(19) United States
(12) Patent Application Publication
(10) Pub. No.: US 2025/0074322 A1
(43) Pub. Date: Mar. 6, 2025

(54) VEHICLE STORAGE SYSTEM

(71) Applicant: Decked LLC, Ketchum, ID (US)

(72) Inventors: Spencer Robert Dahl, Sun Valley, ID (US); James Calvin Allan, Ketchum, ID (US); Shaun Christopher Muston, South Lyon, MI (US); Jordan Daniel Lanning, Boise, ID (US); Samuel Quintrell Wood, Ketchum, ID (US); William Banta, Ketchum, ID (US); John Mason MacArthur, Roseville, MI (US)

(21) Appl. No.: 18/461,420

(22) Filed: Sep. 5, 2023

(51) Int. Cl. B60R 9/06; B62D 33/02

(52) U.S. Cl. CPC B60R 9/06; B62D 33/0207

(57) ABSTRACT

A vehicle storage system may include a deck configured to span substantially a total width of a vehicle bed, four support feet including two front support feet and two rear support feet, a single drawer, and a storage compartment situated between the drawer and a side of the vehicle bed. The deck may include raised portions for coupling to an underside of an accessory case, and tie down attachment points that anchor materials to the deck, while transferring load and connecting the storage system to the truck bed. The drawer assembly may extend outward from the deck to allow full opening of the accessory case without removal of the accessory case from the drawer assembly.

### FIELD OF THE INVENTION

The present invention relates generally to a vehicle storage system, and a method of making such a vehicle storage system.

### BACKGROUND INFORMATION

Existing vehicle storage systems such as truck storage systems generally comprise a box frame or cabinet structure having a drawer that is placed within a vehicle bed such as a truck bed and secured to the truck bed via brackets and holes drilled in the truck bed. Such drawers generally do not extend sufficiently beyond the deck to allow for opening of, and convenient access to, accessory cases placed within the drawer, nor are they dimensioned to allow full utilization of the available storage space within the drawer. Further, the loading and/or hauling of materials on top of the storage systems is rendered more difficult and less reliable as the upper surface of the storage systems are not designed for preventing the slipping and/or sliding of such materials. In addition, storage compartments of existing vehicle storage systems lack versatility, are not sufficiently weatherproof, and are constrained to a limited number of well-defined storage materials or containers. Moreover, these storage systems are designed with a variety of parts that are independently necessary to account for performance requirements, such as heavy loads situated on the storage system, materials anchored to the storage system, and connecting the storage system to the truck bed, thereby adversely affecting both the overall storage system and the vehicle performance.

### SUMMARY

In accordance with an exemplary embodiment of the present invention, a truck storage system may include a deck configured to span substantially a total width of a truck bed, the deck may include a center section and two side sections, the two side sections disposed on opposed sides of the center section and directly adjoining the center section, four support feet, each support foot of the four support feet situated at a respective corner of the center section, a drawer assembly comprising a single drawer situated below the center section and spanning substantially a total width of the center section, the single drawer may be configured to be slidable in the longitudinal direction of the truck bed, and at least one storage compartment situated between the drawer assembly and a side of the truck bed, the at least one storage compartment may be structurally separate from the support feet.

The at least one storage compartment lid may be detachably mounted to a surface of the side sections and configured to restrict access to contents of the at least one storage compartment.

The at least one storage compartment may be at least substantially waterproof, and the at least one storage compartment may be fully removable.

The truck storage system may further include a drawer tray configured to hold contents of the single drawer, aluminum extrusions are disposed on at least one side of the tray, and at least one bracket may be disposed on a cab side of the tray.

The truck storage system may further include at least two tie down attachment members, each tie down attachment member situated between the at least one drawer assembly and the side of the truck bed.

The truck storage system may further include at least two brackets, each bracket connecting a respective tie down attachment member to a channel extending in a longitudinal direction of the truck bed, each of the brackets may be configured to support a load on the deck, anchor cargo in place, and attach the storage system to the truck bed.

The storage system may be attached to the truck bed via a turnbuckle mechanism.

Each of the at least two tie down attachment members may include an attachment ring configured to fold down into a recessed cavity of the side sections and to rotate upward and swivel.

Each of the two side sections may be connected to the drawer assembly via the at least two brackets, and a further bracket may connect the two side sections to a closeout member of the drawer assembly.

The at least one drawer assembly may have side walls that slope at an angle of at most 1 degree.

The at least one drawer assembly may be configured to extend outward of the deck by at least 75% of a length of the at least one drawer assembly.

An upper surface of the deck may have a raised pattern configured to engage a relief pattern on an underside of at least one accessory case to thereby create a positive-fit connection between the deck and the at least one accessory case.

The raised pattern may cover a majority of the upper surface of the deck.

The truck storage system may further include at least two tie down attachment members, each tie down attachment member situated between the at least one drawer assembly and the side of the truck bed, an area between the at least two tie down attachment members does not contain the raised pattern.

The truck storage system may further include lateral steel tubes spanning across the center section to the two side sections.

The front support foot and the rear support foot may be dimensionally different.

The truck storage system may further include at least one closeout member which may be configured to provide stability to the deck and to prevent an ingress of water into the at least one drawer assembly.

In accordance with a second exemplary embodiment of the present invention, the truck storage system may include a deck configured to span substantially a total width of a truck bed, the deck may include a center section and two side sections, the two side sections disposed on opposed sides of the center section and directly adjoining the center section, four support feet, each support foot of the four support feet situated at a respective corner of the center section, a drawer assembly comprising a single drawer situated below the center section and spanning substantially a total width of the center section, the single drawer configured to be slidable in the longitudinal direction of the truck bed, a drawer tray configured to hold contents of the single drawer, aluminum extrusions disposed on at least one side of the drawer tray, and at least one bracket may be disposed on a cab side of the drawer tray to attach the tray to the drawer assembly and to support the contents, and at least one storage compartment situated between the drawer assembly and a side of the truck bed, the at least one storage compartment may be structurally separate from the support feet.

In accordance with a third exemplary embodiment of the present invention, the truck storage system may include a deck configured to span substantially a total width of a truck bed, the deck including a center section and two side sections, the two side sections disposed on opposed sides of the center section and directly adjoining the center section, four support feet, each support foot of the four support feet situated at a respective corner of the center section, a drawer assembly comprising a single drawer situated below the center section and spanning substantially a total width of the center section, the single drawer may be configured to be slidable in the longitudinal direction of the truck bed, and at least one storage compartment situated between the drawer assembly and a side of the truck bed, the at least one storage compartment may be structurally separate from the support feet, each of the two side sections are connected to the drawer assembly via (i) brackets connected to the support feet and (ii) a further bracket connected to a closeout member of the drawer assembly.

Example embodiments of the present invention are described in more detail below with reference to the appended Figures.

### BRIEF DESCRIPTION OF THE DRAWINGS

FIG. 1 shows a top perspective view of a first exemplary embodiment of a truck storage system according to the present invention.

FIG. 2 shows a partially exploded view of the first exemplary embodiment of a truck storage system according to the present invention.

FIGS. 3A to 3E show top perspective, bottom perspective, top, bottom and lateral side views, respectively, of a center section of a deck of a truck storage system according to the present invention.

FIGS. 4A to 4E show top perspective, bottom perspective, top, bottom and lateral side views, respectively, of a right side section of a deck of a truck storage system according to the present invention.

FIGS. 5A to 5E show top perspective, bottom perspective, top, bottom and lateral side views, respectively, of a left side section of a deck of a truck storage system according to the present invention.

FIGS. 6A to 6D show top perspective, top, front/rear and lateral side views, respectively, of a rear support foot of a truck storage system according to the present invention. Foot A is driver-rear w/axle and pass-front no axle. Foot B is driver-front no axle and pass-rear with axle.

FIGS. 7A to 7D show top perspective, top, front/rear and lateral side views, respectively, of a front support foot assembly of a truck storage system according to the present invention. Foot A is driver-rear w/axle and pass-front no axle. Foot B is driver-front no axle and pass-rear with axle.

FIGS. 8A to 8E show top perspective, top, front/rear and lateral side views, respectively, of a storage container assembly of a truck storage system according to the present invention.

FIGS. 9A to 9F show top perspective, bottom perspective, top, bottom, front/rear and lateral side views, respectively, of a storage container cover of a truck storage system according to the present invention.

FIGS. 10A to 10D show top perspective, top, front/rear and lateral side views, respectively, of a tie down member of a truck storage system according to the present invention.

FIGS. 11A to 11D show top perspective, top, front/rear and lateral side views, respectively, of a closeout member of a truck storage system according to the present invention.

FIGS. 12A to 12C show top perspective, front/rear and lateral side views, respectively, of a guide channel of a truck storage system according to the present invention.

FIG. 13 shows a top perspective view of a deck with a drawer assembly extended outward of a truck storage system according to the present invention.

FIGS. 14A to 14F show top perspective, top, rear, lateral side, cross-sectional and close-up cross-sectional views, respectively, of a drawer assembly of a truck storage system according to the present invention. FIG. 14E is a cross-sectional view along line A-A shown in FIG. 14D, and FIG. 14F is a close-up cross-sectional view of the circled portion shown in FIG. 13E.

FIGS. 15A to 15D show top perspective, rear, front and lateral side views, respectively, of a deck with a drawer assembly extended at a slight incline according to the present invention.

### DETAILED DESCRIPTION

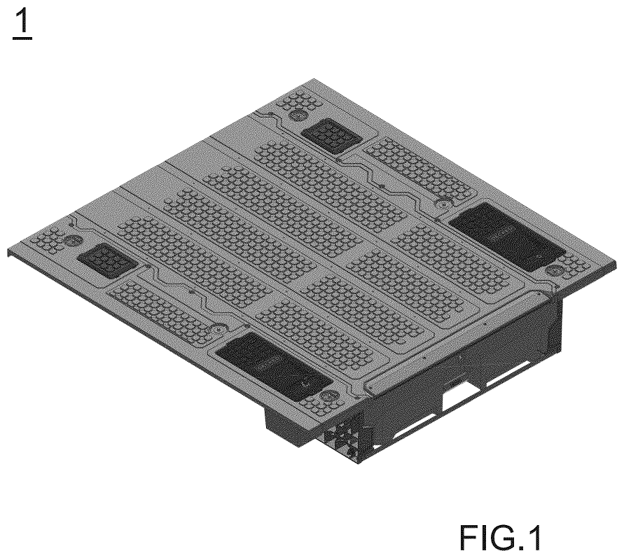

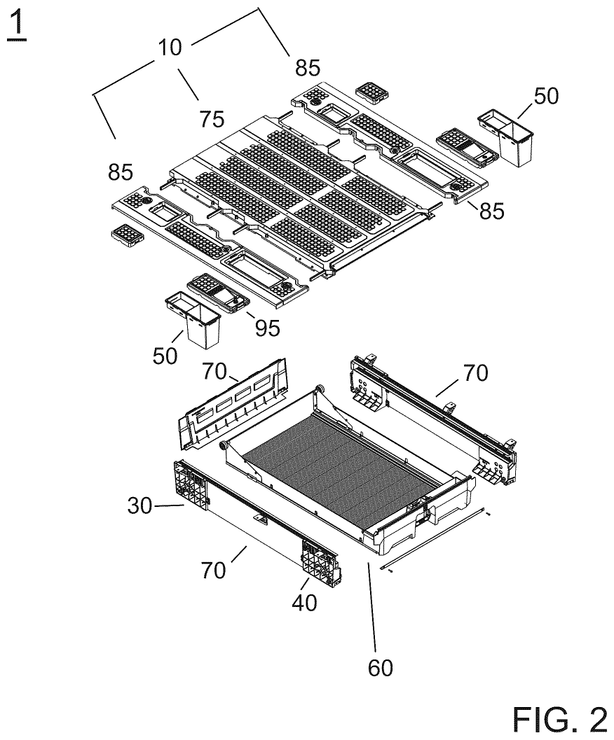

FIG. 1 shows a top perspective view and FIG. 2 shows a partially exploded view of a first exemplary embodiment of a truck storage system 1 according to the present invention. As shown in FIGS. 1 and 2, the truck storage system 1 may comprise a deck 10 having a center section 75 and two side sections or wingers 85, front support feet 30, rear support feet 40, storage compartments 50, storage compartment covers 95, drawer assembly 60, and closeouts 70, all of which will be described further herein. The truck storage system 1 may be sized to fit both long and short truck beds, and may cover substantially the full width of the truck bed, as shown in FIG. 1, for example.

As used herein, the terms “front,” “rear,” “left side,” and “right side” refer to directions with reference to a vehicle, e.g., a pickup truck, in which the truck storage system may be installed. For example, the term “front” refers to a forward-moving direction of the vehicle, the term “rear” refers to a rearward-moving direction of the vehicle, the term “left side” refers to a driver side of the vehicle (as commonly used in the U.S.), and the term “right side” refers to a passenger side of the vehicle (as commonly used in the U.S.).

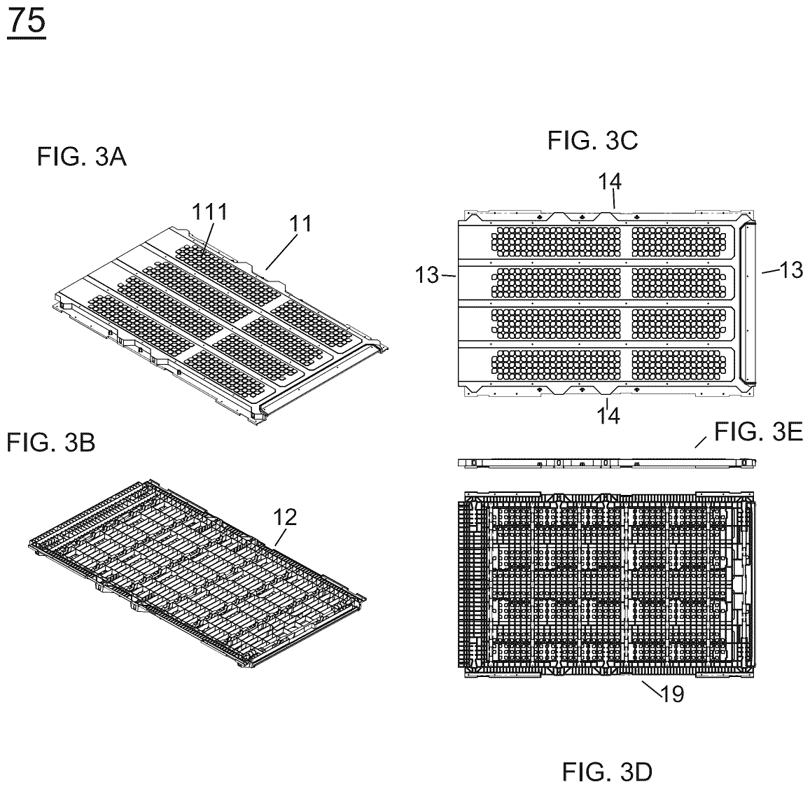

FIGS. 3A to 3E show various views of a center section 75 of a deck 10 of a truck storage system 1 according to the present invention.

The center section 75 of the deck 10 may include an upper surface 11, a lower surface 12, front and rear edges 13, and lateral side edges 14. The center section 75 of the deck 10 may be made of high density polyethylene, other plastics, metals, or combinations thereof, for example. The upper surface 11 may include one or more surface treatments which may provide traction to prevent slipping and/or sliding of materials, such as, for example, one or more accessory cases placed upon the upper surface 11. For example, the upper surface 11 may include a raised portion 111 in one or more distinct areas of the upper surface 11. The raised portion 111 may be, for example, in the form of a pattern or series of uniformly spaced protrusions or bumps.

The raised portion 111 may correspond to an underside of one or more accessory cases having surfaces with one or more reliefs or grooves or holes. This correspondence may create a positive-fit connection between the deck 10 and the one or more accessory cases. The perimeter of at least sections of the raised portions 111 may enclose respective reliefs or grooves or holes of the one or more accessory cases. The raised portions 111 may thereby be adapted to engage with the corresponding or complimentary reliefs, holes, or grooves of the one or more accessory cases. The depth and shape of each relief, hole, or groove may correspond to a depth and shape of the protrusions or bumps such that they have corresponding profiles. Moreover, the distribution of the raised portions 111 may be selected based on the distribution of the reliefs or vice versa. The upper surface 11 of the deck may thereby prevent or reduce a lateral displacement of the accessory case with respect to the deck 10. The reliefs on the underside of the accessory case may guide the placement and/or reception and/or attachment of the accessory case to the upper surface 11 of the deck 10, and thereby prevent the slipping and/or sliding of and/or disengagement of the accessory case. In an alternative embodiment, other mechanisms for preventing the slipping and/or sliding and/or disengagement of the accessory case may be employed such that a connection and/or friction between the accessory case and the upper surface 11 of the deck 10 would secure and/or stabilize the accessory case to the deck 10.

As shown in FIG. 1, the deck 10 may include the raised portions 111 in different areas along the upper surface 11. For example, the deck 10 may include raised portions 111 throughout the upper surface 11 or only over a majority of the upper surface 11 of the deck 10. In an example embodiment, a section of the center section 75 of the deck 10, between two corresponding tie-downs, discussed below, may be generally flat without containing any raised portions 111. In addition, any such section between two corresponding tie-downs may be similarly flat. Furthermore, the upper surface 11 may be divided into sections, for example, four sections, which are separated from each other by flat sections of deck 10. This may be beneficial so that an accessory case placed upon one of the raised sections of deck 10, e.g. a first section, does not inadvertently or unexpectedly travel to a different section, for example, a second section of deck 10 in response to a movement of the vehicle. Alternatively or additionally, an area adjacent to the tie-downs 211, discussed below, may be generally flat without containing raised portions 111. This may be beneficial so that items may be conveniently and/or efficiently mounted via, for example, rails at or near a location of a tie-down 211.

Different areas of the upper surface 11 may include different patterns of raised portions 111 to accommodate different patterns of reliefs of, for example, multiple accessory cases. For example, one or more areas along upper surface 11 may have raised portions 111 that are closer to each other or have wider portions, while other areas along upper surface 11 may have raised portions 111 that are farther apart or have narrower portions. The raised portions 111 may allow for various orientations or placements of one or more accessory cases on top of the deck 10.

Additionally, the upper surface 11 may include mounts, tracks, guides or rails for securing materials placed on the upper surface 11, and/or may include various functional and/or decorative indicia or surface treatments, such as, for example, embossing, debossing, texturing (e.g., graining), engraving, printing, etc.

The deck 10 may include a plurality of reinforcement beams 19, as shown in FIGS. 3B, 3D, and 3E, for example, that traverse the deck 10 from a first lateral side edge 14 to a second lateral side edge 14. The reinforcement beams 19 may be made of high density polyethylene, other plastics, metals, or combinations thereof, for example, and may provide sufficient stiffness and support for the deck 10 and materials loaded thereon. The reinforcement beams 19 may have a cross-section that is round, square, rectangle, I-beam, L-beam, and/or may taper. The reinforcement beams 19 may be made of a single part or multiple parts attached together.

The lateral side edges 14 of the deck 10 may be processed to match the sidewall profiles 91 of the side sections or wingers 85, and the side sections or wingers 85 may be processed to match the sidewall profiles of the truck bed in which the truck storage system 1 is to be installed. For example, the lateral side edges 14 of the deck 10 may be cut, machined, laser cut, waterjet cut, or otherwise modified to precisely match the sidewall profiles 91 of the side sections or wingers 85, and the side sections or wingers 85 may be cut, machined, laser cut, waterjet cut, or otherwise modified to precisely match the sidewall profiles of the truck bed in which the truck storage system 1 is to be installed, which sidewall profiles differ between various truck manufacturers and models, and may also differ between left and right sides on a single truck model.

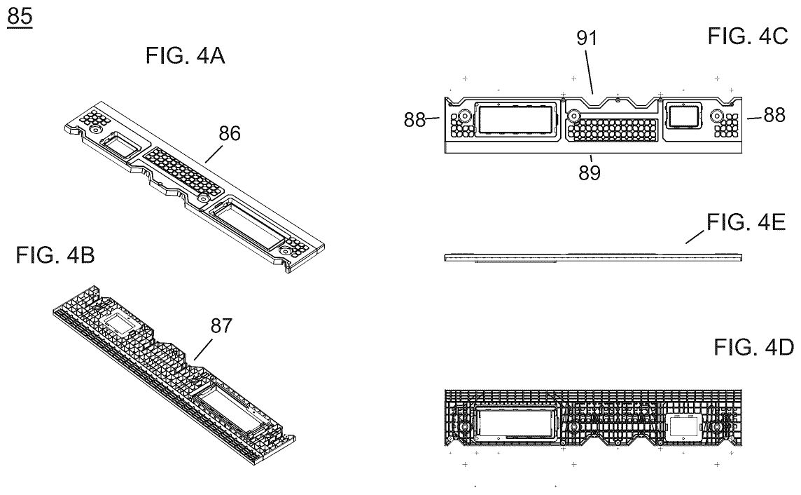

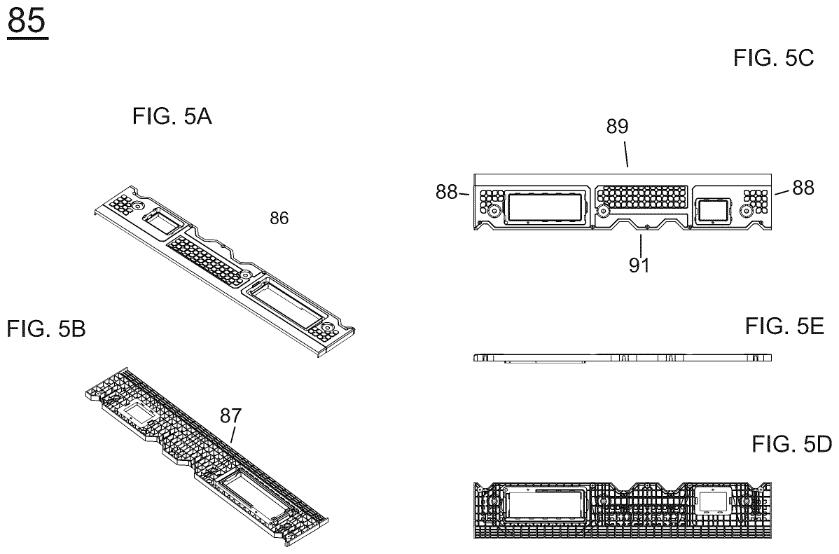

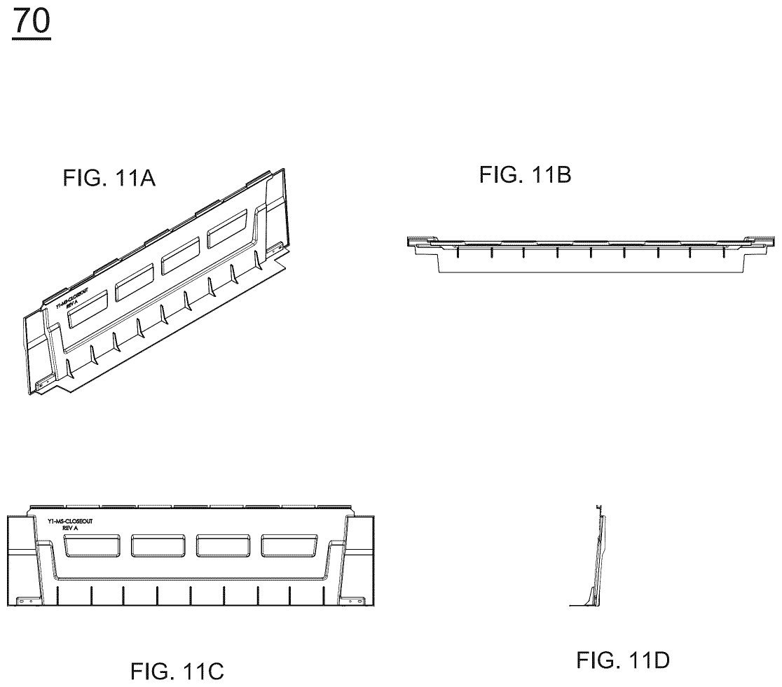

The deck 10 may have attached thereto two side sections or wingers 85, one on each side of the deck 10, as shown in FIGS. 4A to 5E. FIGS. 4A-4E show the right-side sections or wingers 85R, while FIGS. 5A-5E show the left-side sections or wingers 85L. Each winger 85R, 85L of the deck 10 may include an upper surface 86, a lower surface 87, front and rear edges 88, lateral side edges 89, and sidewall 91. Wingers 85 may be custom cut to fit into different sides of a myriad of truck bed. Each winger 85 may be connected to the center section 75 of deck 10 via brackets, which brackets may be used as part of the tie downs 211. One or more brackets, such as two brackets, may connect the wingers 85 to the support feet, for example connected to a front support foot 30 and to a rear support foot 40, which support feet may be connected to the drawer assembly 60. In addition, one or more brackets, such as a third bracket, may connect the wingers 85 to a middle portion of a side of drawer assembly 60, which may be a closeout 70, as shown in FIGS. 11A-11D. The deck 10 may also have lateral steel tubes that span across the center section 75 of the deck and extend outward of the center section 75 to the wingers 85.

Each winger 85 may include a storage compartment opening 16 that mates with a rear storage compartment 50. Fasteners and/or adhesives may be used to secure the side sections or wingers 85 of deck 10 to rear storage compartment 50. Between storage compartment 50 and deck 10, geometry may exist to further route water such as, for example, gaskets, spouts, drill edges, to prevent ingress.

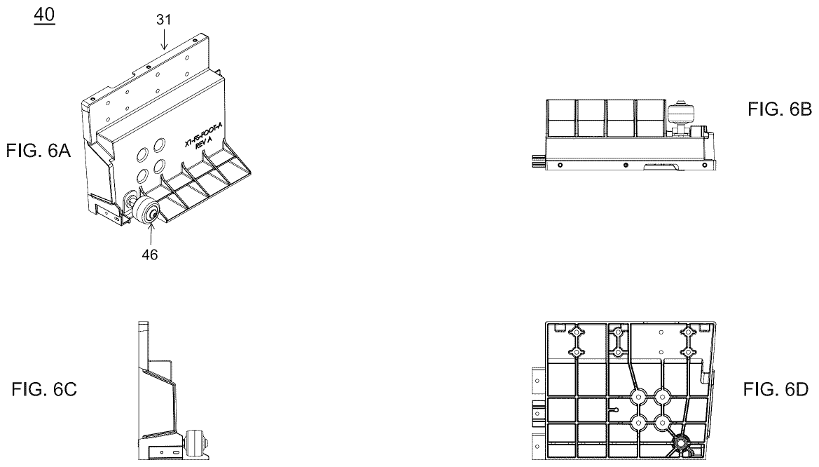

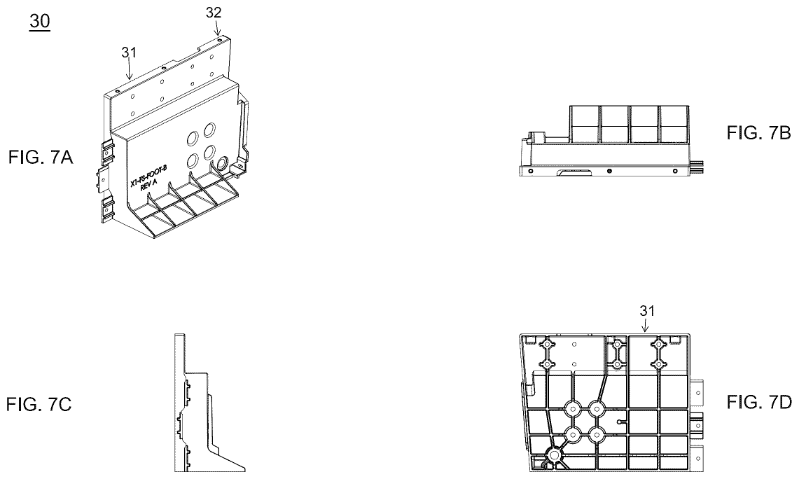

FIGS. 6A to 6D and 7A to 7D show various views of a front support foot assembly 30 and a rear support foot assembly 40 of a truck storage system according to the present invention. Foot A is driver-rear w/axle and pass-front no axle. Foot B is driver-front no axle and pass-rear with axle. One front support foot 30 may be configured to be attached to the deck 10 in each of the front, driver side corner and the front, passenger side corner of the truck storage system 1, and one rear support foot assembly 40 may be configured to be attached to the deck 10 in each of the rear, driver side corner and the rear, passenger side corner of the truck storage system 1, as shown in FIG. 2, for example. The front and rear support feet 30, 40 may be made of high density polyethylene, other plastics, metals, combinations thereof, and/or may include composites such as fiberglass, for example. The front and rear support feet 30, 40 may include an upper surface 31 having holes 32 that align with a surface above for attachment between the center section 75 of deck 10 and the front and rear support feet 30, 40. For example, fasteners and/or adhesives may be inserted through holes 32, to secure the center section 75 of deck 10 to the front and rear support feet 30, 40. The front and rear support feet 30, 40 may also include a lower surface 33 that rests on the truck bed. Geometry of the lower surface 33 may be maximized in, for example, dimensions, geometry, and texture, to provide maximal stability with the truck bed surface.

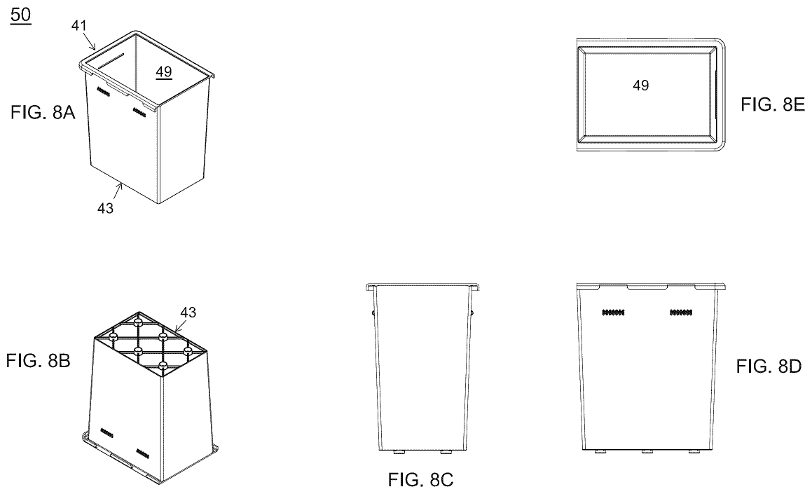

FIGS. 8A to 8E show various views of a storage container/compartment 50 of a truck storage system according to the present invention. Between the upper surface 41 and lower surface 43, the storage compartment 50 may define a compartment 49 in which beverages, tools, fasteners or any other items may be placed.

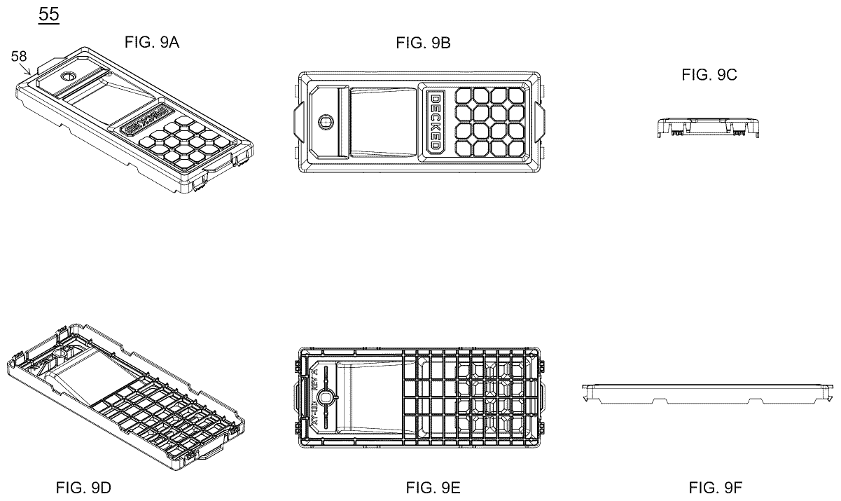

The storage compartment 50 may be structurally separate from the support feet 30, 40 such that they are at least situated in spaced relation along at least a width direction of the vehicle bed. This provides the advantage that the storage compartment 50 and the support feet 30, 40 are each essentially independent units which allows for a simple and economical manufacture and use of each structure. In addition, each individual structure can be separately removed and replaced without adversely affecting the other structure. For example, the storage compartment 50 may be removed and replaced without affecting the support feet 30, 40 which may be currently supporting the center section 75 of the deck 10. The compartment 49 may be or may contain one or more stash bins, buckets, and/or bags which are configured for storage of items. The stash bins, buckets, and/or bags are configured to fit within the compartment 49, which is sized to receive the one or more stash bins, buckets, and/or bags by a loose fit, press fit, snap fit, and twist fit connection. The stash bins, buckets, and/or bags may be fully or partially removable from within the compartment 49. The stash bins, buckets, and/or bags may be situated within the compartments 49 such that an upper portion of the stash bins, buckets, and/or bags spans a horizontal area of the side sections or wingers 85 of deck 10. For example, an upper rim of the stash bins, buckets, and/or bags may be configured so that they outwardly extend and/or hang on a lip of the side sections or wingers 85 of deck 10. The one or more stash bins, buckets, and/or bags may be the same size or have different sizes to allow for convenient storage and removal of different sized items within the one or more stash bins, buckets, and/or bags. The compartment 49 may be fitted with one or more removable covers or lids 95, as shown in FIGS. 9A to 9F to weatherproof the items within the compartment 49 when the lid 95 is in a closed position. Specifically, when the lid 95 is closed, it may seal any gaps that exist to thereby weatherproof the compartment 49. Further, the upper surface 41 may include drain holes (not shown), e.g., forward and rearward drain holes, to direct water or other substances away from the compartment 49 and down toward the truck bed. The covers or lids 95 may be fully removable or may be movably hinged and pivot between fully closed and opened positions. The covers or lids 95 may be fitted with compressible materials such as, for example, foam and/or rubber, to further seal out water and/or dust.

The various compartments 49 may only be located in the rear of the truck storage system 1. In an alternative embodiment, compartments may also be located in the front, in which case they may be of the same size of different sizes relative to the rear compartments. For example, the compartments adjacent to the rear support feet 40 may be larger than the compartments 49 adjacent to the front support feet 30, thus allowing for a larger area of storage in compartments adjacent to the rear support feet 40 relative to compartments adjacent to the front support feet 30. In an example embodiment, there may be two rear stash bins, which may be of different sizes, for example, a smaller and larger size within the rear storage compartment 50, while there may be one front stash bin within the front storage compartment 50. Each storage compartment 50 may be sealed with a lid 95 that corresponds to the size and shape of the respective compartment 49. Thus, for example, the compartment lid 95 for the rear storage compartment 50 may be larger than the compartment lid 95 for the front storage compartment 50. The compartments 49 may be secured to the lids 85 via a lock member to prevent unauthorized entry.

As mentioned, FIGS. 9A to 9F show various views of stash bin lids/covers 95 of a truck storage system 1 according to the present invention. The cover 95 may be made of high density polyethylene, other plastics, metals, or combinations thereof, for example. The cover 95 may be configured to fit snugly, e.g., by friction fit or snap fit, within openings 16 of the deck 10, and to mate and/or substantially seal with upper surfaces 41 of the front and rear stash bins 50. A finger access lip 59 may be provided on an edge of cover 95, and a corresponding finger access recess may be provided on deck 10 to facilitate removal of the covers 95. An upper surface of cover 95 may include various functional and/or decorative indicia 51 or other surface treatment formed by, for example, embossing, debossing, texturing (e.g., graining), engraving, printing, etc. For example, the surface treatment of the upper surface of cover 95 may provide traction to prevent slipping and/or sliding of materials placed on the upper surface. A lower surface of cover 95 may include cup holders 52 and/or other areas 53 for the placement of cups, tools, fasteners or any other objects, when the cover 95 is removed from opening 16 or when the cover 95 is placed upside down within opening 16.

In addition, the front and rear storage compartments 50 may include substantially spherical, semispherical or rounded attachment points. Preferably, the attachment points of the front and rear storage compartments 50 may be secured to existing brackets, holes or tie-down points in the truck bed via a turnbuckle assembly 411. The turnbuckle assembly 411 may include a hook on both ends and a middle portion that twists for tightening and tensioning. One hook associated with the turnbuckle 411 may be positioned around a bracket. The turnbuckle assembly 411 may be configured to hook around an attachment point in order to secure the turnbuckle assembly 411 at variously placed existing brackets, holes or tie-down points of the truck bed. Accordingly, the storage compartments 50 may be installed in the truck bed without requiring structural modification of the truck bed, such as for example, drilling holes in or bending/deforming the truck bed, since the turnbuckle assembly 411 may be attached to existing brackets, holes or tie-down points of the truck bed. Additionally, further brackets may be installed in the truck bed at existing holes or tie-down points to facilitate the use of the turnbuckle assembly 411 for securing the storage compartments 50. The turnbuckle assembly 411 may be made of high density polyethylene, other plastics, metals, or combinations thereof, for example.

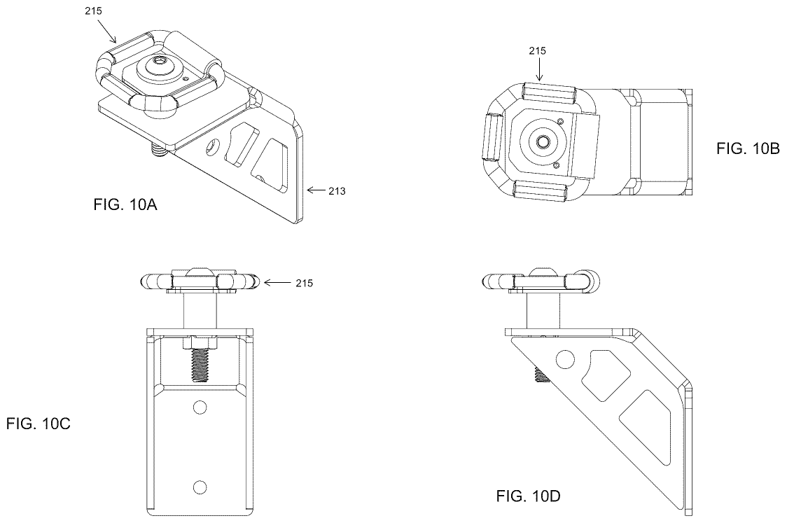

Each of the wingers 85 may include a plurality of tie-downs 211, as shown in FIGS. 10A-10D, for example, that are located at intervals along the upper surface 11 of the wingers 85 and traverse the upper surface 11 of the deck 10 laterally from the rear support feet 30 to the front support feet 40. For example, each of the wingers 85 may include three tie-down holes and underlying brackets running up each side. In an alternative embodiment, such as for example, for use with the Maverick or Rivian, each of the wingers 85 may include two tie-down holes and underlying brackets running up each side.

The tie-downs 211 may be equally spaced apart along the wingers 85 extending laterally from one end of the winger 85 to the other end of the winger 85. The tie-downs 211 may include a hook, for example, in the form of a D-ring, which may be disposed above the surface of the deck 10 when in use and which may serve to anchor and/or secure cargo. The D-ring may be recessed within a pocket of the winger 85 when not in use to prevent, for example, snagging or accidental catching of accessories placed upon the winger 85. The lower portions of the tie-downs 211 may be embedded within the winger 85.

The brackets 213 may be welded steel brackets that are fastened to a respective tie down 211 and bolted to the C channel to transfer load to the truck bed. The brackets 213 may thereby serve at least three independent and simultaneous functions: to support load from above, act as a tie-down anchor for items placed above using, for example, a D-ring 215, and to assist with the deck 10 attachment to the truck bed.

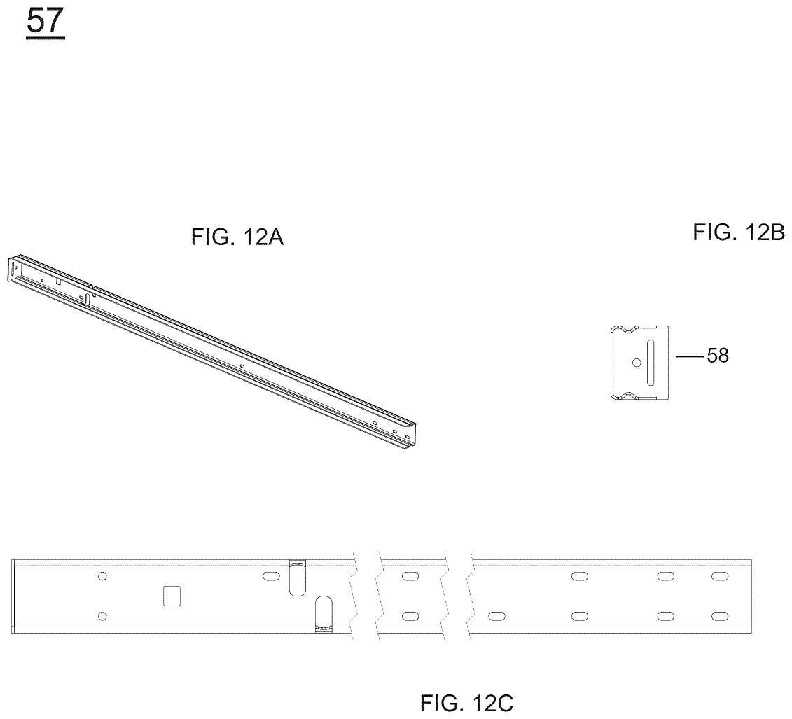

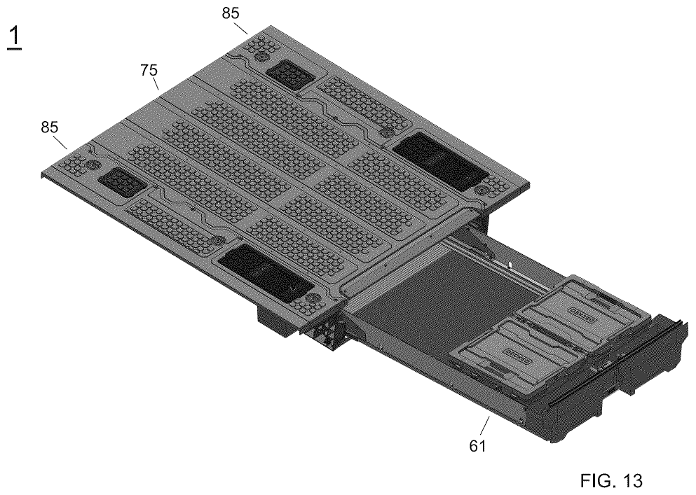

Further, the front and rear support feet 30, 40 may include at least one guide channel surface on which a guide channel 57, as shown in FIGS. 12A to 12C, for example, may rest and/or be secured. The guide channel 57 may be made of high density polyethylene, other plastics, metals, or combinations thereof, for example. The guide channel 57 may be attached to the front and rear support feet 30, 40 by fasteners and/or adhesives, and extend in a front-to-rear direction between front and rear support feet 30, 40 provided on a same side (i.e., driver side or passenger side) of the truck storage system 1, as shown in FIG. 2, for example. The guide channel 57 may include at least one self-centering formation 58 that is configured to maintain wheels 63 provided on the drawer 60 that roll within the guide channel 57 in an optimal position, e.g., both vertical position, as well as horizontal or lateral position, for smoothly opening/closing a drawer 60, as shown in FIG. 13, for example.

The rear support foot assembly 40 may further include a wheel 46 that may be provided at a rearward lower portion of the rear support foot assembly 40. That is, for a rear support foot assembly 40 provided at the rear, driver side corner of the truck storage system 1, the wheel is attached at one location, whereas for a rear support foot assembly 40 provided at the rear, passenger side corner (i.e., rotated 180 degrees from the rear, driver side corner position) of the truck storage system 1, the wheel 46 may be attached to a different location. The wheels 46 of the rear support foot assemblies 40 cooperate with wheels 23 of drawer 60 to facilitate sliding of drawer 60.

FIG. 13 shows a truck storage system 1 of the present invention with the drawer assembly 60 extended outward. The drawer 61 may have a width such that it can simultaneously hold two accessory cases side by side within the drawer in a width direction or longitudinal direction of the vehicle bed, as shown in FIG. 13.

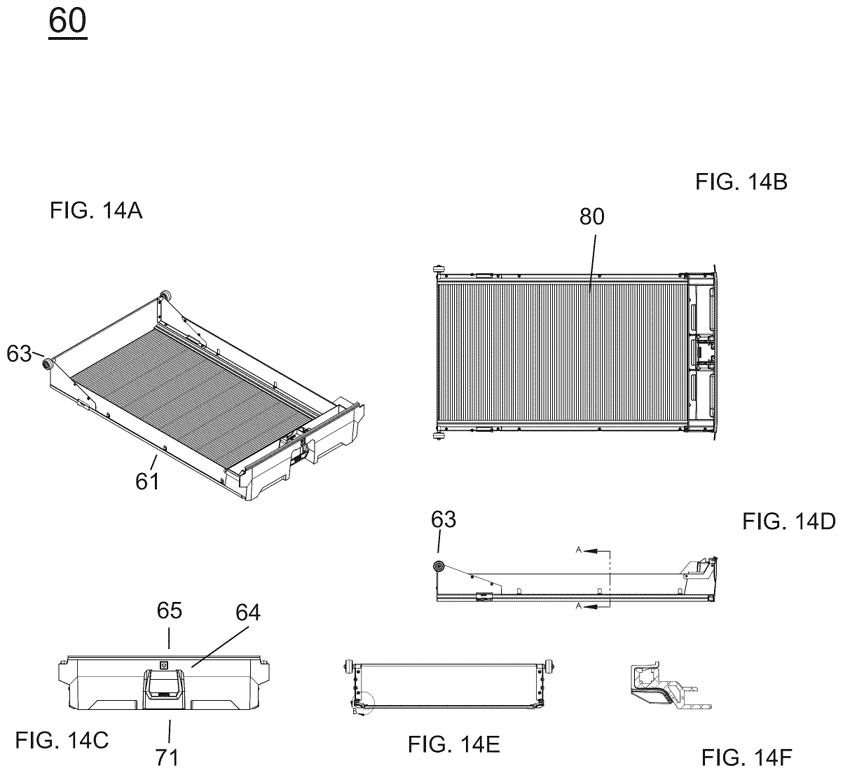

FIG. 14A to 14F show various views of a drawer assembly 60 of a truck storage system 1 according to the present invention. The drawer assembly 60 may be made of high density polyethylene, other plastics, metals, or combinations thereof, for example. Each drawer assembly 60 may be rated to carry a payload of about 400 lbs, for example. In addition, the truck storage system 1 can support approximately 1000 lbs of load on its deck 10.

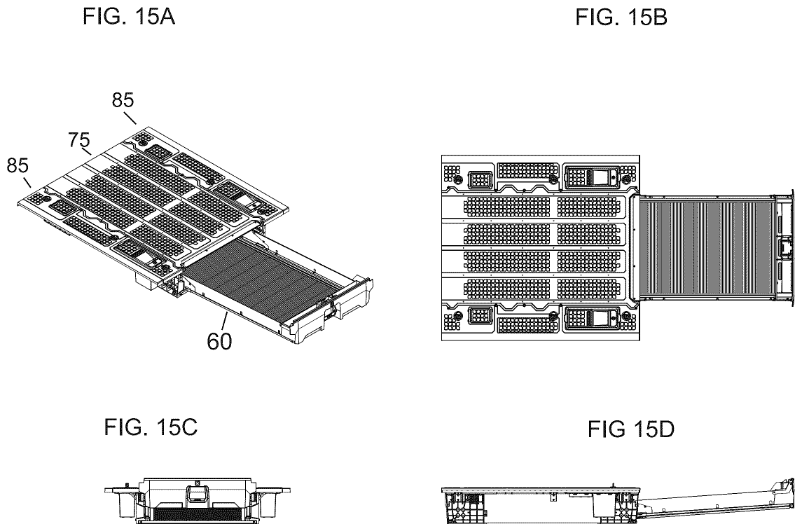

The drawer assembly 60 may include a single drawer 61, integral wheel channels 62, wheels 63, wheel bracket assemblies 66, integral handle 64, lock 65 and latch assembly 71. Single drawer 61 may be configured to receive materials therein, and may include notches or other formations to transversely receive drawer dividers, as shown in FIGS. 15A to 15B, for example, and the single drawer 61 may receive a tray/mat 80 along its inner bottom surface. The drawer dividers may include notches or other formations to allow the placement of longer items within single drawer 61 when using dividers or to facilitate the use of ropes, cords or other items for tying down and/or securing items within the single drawer 61. Alternatively, drawer dividers that extend in a front-to-rear direction of the single drawer 61 may also be provided. The drawer dividers may be made of plastic, steel, foam, or any other suitable combination and may be clipped to an underside of a rail of single drawer 61.

The tray 80 may include aluminum extrusions that run up one or more sides of the tray 80 and grab the tray 80 which help support a load above the tray 80.

Drawer 61 may have a rail mounting system that may include a variety of fasteners which may allow for the addition of one or more walls to the sides of the drawer 61 and/or may allow for the drawer dividers to be placed width-wise along the drawer 61. Alternatively, drawer dividers that extend in a front-to-rear direction of the drawer 61 may also be provided. The drawer dividers may be made of plastic, steel, foam, or any other suitable combination and may be clipped to an underside of a rail of the drawer 61.

On a cab side of the tray 80, brackets may be used to attach the tray 80 to a rear wall of drawer 61 as well as an inner side of the rear support feet 40 to at least one of provide strength to the tray/drawer and allow for the stabilize positioning of the tray/drawer. Below the tray 80, a stub axle/wheel may provide additional support to the load forces that are transferred below the drawer 61. When the drawer is loaded and/or extended, load forces may be transferred into the C-channel running along the side of the drawer.

Drawer 61 and tray 80 may extend at a slight incline to counteract the downward forces resulting from extension and load, as shown in FIG. 15D, thereby allowing for a more level tray 80 when loaded.

The tray 80 may be constructed of any material suitable for holding objects and capable of withstanding the load, such as, for example, plywood, and/or aluminum, and/or plastic or any combination thereof such as, for example, plastic molded over steel stubs.

In addition, the integral handle 64 of drawer 61 may be initially molded into the drawer 61 and facilitate opening, closing and/or grasping of the drawer assemblies 60. An integral handle may also be provided at opposite end of drawer 61 to facilitate grasping of the drawer assemblies 60, for example, when removed from the truck storage system 1. Further, the drawer 61 may be configured to allow nesting of multiple components within each other for packaging, shipping and/or storage by appropriate design of, for example, the sidewalls, integral wheel channels 62 and integral handle 64 of the drawer 61.

The side walls of drawer 61 may slope at an angle of at most 1 degree between an upper surface of the drawer and a lower surface of the drawer. In an example embodiment, the side walls of drawer 61 may slope at an angle of at most degree. These reduced slopes result in an increased drawer volume and may allow an essentially cubed shaped accessory case to fit within, and make full use of the interior space of the drawer 61. In addition, the reduced slope may allow for secure and modular stacking of multiple accessory cases.

The front of the drawer 61 may include, for example, a facade near the tail gate which may disrupt potential ingress of dust/water/debris into the drawers 61. In addition, the top of the drawer 61 may have a facade that includes a weather-strip to further prevent ingress.

When the drawer 61 is extended out from the deck to a distance greater than a length of an accessory case, the lid of the accessory case may be rotated upward at least 100 degrees from a closed position while still situated within the interior space of the drawer 61. The lid may be rotated upward at a side opposite the hinged side to thereby gain access to the space within the accessory case.

Drawer 61 may contain metal brackets, such as, for example, L brackets or corner braces which are disposed at an approximate midportion of the drawer 61, such as where wheel stops on the underside of the drawer 61 may be situated, and bolted securely to the bottom and side walls of the drawer 61.

The brackets may serve to provide additional strength and reinforcement to the drawer 61, without inhibiting access thereto, due to their lower profile designs. The brackets may also allow the drawer 61 to be extended further out from a stowed position from within the deck, thereby affording improved access to a greater portion of the interior volume of the drawer 61. At full extension, the drawer 61 may be capable of withstanding 200 lbs of weight. In an example embodiment, for a long truck bed (approximately 6.5 feet), the drawer 61, which may be 72 inches in length, may be extended outward 59 inches beyond the deck. In addition, each side of drawer 61 may include lateral steel tubes, which may be installed after molding, for increasing the strength of drawer 61.

Lock 65 may allow locking of the drawer assembly 60 in the fully closed position. The lock 65, as shown in FIGS. 14A to 14D, for example, may include a locking cam 65a that can rotate between an open position and a closed position. In an open position, the locking cam 65a allows the drawer assembly 60 to be pulled out of the truck storage system 1. In the closed position, the locking cam 65a may cooperate with structure on the lower surface 12 of the deck 10 to prevent pulling out of the drawer assembly 60. For example, the locking cam 65a may engage with a reinforcement beam 19 that at least partially protrudes from the lower surface 12 of the deck 10, thereby not requiring any additional structural features to be molded into the deck halves 10 to provide the locking function. Alternatively, the locking cam 65a may engage with other structure on the lower surface 12 of the deck halves 10.

All components of the truck storage system 1 may be made in long and short versions that correspond to long truck bed designs of approximately 6 feet and short truck bed designs of approximately 5 feet. For example, components such as the deck 10, guide channels 57, drawer assembly 60, and trim piece 90 may be manufactured in long and short versions. Only one set of tooling may be needed for these components, in which tool inserts may be inserted/removed for manufacturing long vs. short versions. Thus, long and short variations of the truck storage system 1 may be economically manufactured with one set of tooling. Moreover, the non-handedness of many of the components of the truck storage system 1, such as for example, the deck 10, guide channel 47, and drawer assembly 60, may further allow for economical manufacture of the storage system 1.

Furthermore, all components of the truck storage system 1 may be designed to fit within myriad truck bed designs of truck manufacturers. For example, the truck storage system 1 may be designed to accommodate mid-sized pickup trucks, such as, for example, the Tacoma, Ranger, and Gladiator, with bed lengths of approximately 5 ft and 6 ft, and which may be narrower than full-size pickup trucks. In addition, the components of the truck storage system 1 may be designed to fit, with minor adjustments within truck bed designs of, for example, the Rivian and Maverick, which have smaller truck beds and are narrower than other mid-sized trucks. For example, lateral side edges of the side sections or wingers 85 may be processed to fit within any one of the myriad truck bed designs. In this respect, truck beds generally have an undulating surface from the driver side to the passenger side of the truck bed, e.g., an alternating series of upstanding and downstanding beads. As a result, the width of the lower surface of the drawer may be designed to rest securely on the variously designed undulating surfaces of any one of the myriad truck bed designs, e.g., on one upstanding bead, or on two upstanding beads and straddling one downstanding bead. Similarly, the front and rear support feet 30, 40 may be designed to rest securely on the variously designed undulating surfaces of any one of the myriad truck bed designs. Further, the front and rear support feet 30, 40 may be designed to interface with existing holes, brackets or tie-down points of any one of the myriad truck bed designs.

In addition, the bottom surface of the drawers 61 may be designed with a notch, a raised surface and/or a sloped surface configured to provide clearance to a lowered tailgate. Truck bed and tailgate designs of various truck manufacturers provide different angles of inclination, i.e., tailgate ramp angle, of the lowered tailgate with respect to the plane of the bottom surface of the truck bed, and the largest of the different angles of inclination is approximately 2.5 degrees. Thus, in order to provide clearance for fully opening the drawer assembly 60, a notch, a raised surface and/or a sloped surface may be provided on the bottom surface of the drawer 61, such that a single drawer design can be used in any one of myriad truck bed designs. Accordingly, a single design of truck storage system 1 can be used by owners of any one of the myriad truck bed designs of truck manufacturers. In addition, the bottom surface of the drawers 61 may include geometry (e.g. a dimple or boss) to indicate optimal location of a drain. The drain feature may be formed by the user drilling through the drawer surface.

As a result, if an owner has installed the truck storage system 1 in an old truck, but then sells the old truck and purchases a new, different truck, the owner can simply remove the existing truck storage system 1 from the old truck, purchase only new side sections or wingers 85 having lateral side edges processed to fit within the new truck, and reinstall all other components of the existing truck storage system 1 in the new truck with the new deck 10.

All components of the truck storage system 1 may be configured to nest within each other for packaging, shipping and/or storage, for example. As described herein, components such as front support feet 30, rear support feet 40, storage compartment covers 95, lock 65, drawer dividers, latch assembly 70, tray 80, stash bins 50, wheels, fasteners, brackets, and/or adhesives, and any other small parts may be placed within drawer assembly 60. The remaining components, such as the deck 10, guide channels 57, and any other large parts such as accessory cases may be packaged together with the drawer assembly 60 or other components. Alternatively, the deck 10 may be packaged and/or shipped separately from the remaining components.

All components of the truck storage system 1 may be made of high density polyethylene, other plastics, metals, or combinations thereof, for example. Since the storage system 1 is to be installed in truck beds that are typically exposed to the environment and may encounter heavy loads and rough use, it may be advantageous to use materials that have high corrosion resistance. For example, high density polyethylene (HDPE) may be particularly advantageous for providing high strength, low weight and good corrosion resistance. In addition, the HDPE (or other plastic, metal, etc.) may be treated/molded with compounds that prevent/limit degradation due to UV exposure. In addition, additives or surface treatments may be included that improve mechanical performance across a broader range of temperatures. Thus, the storage system 1 may have a long useful service life, and may be rated for carrying heavy loads suitable for the truck bed alone without adding excessive weight that may adversely affect the performance of the vehicle.

For use with vehicles such as the Maverick or Rivian, the above truck storage system 1 may be customized in at least the following manner: one or more storage compartments 50 may be removed from the system to allow for proper fitting and configuration within the respective truck bed, the center section 75 may be configured of have a shorter length, access holes may be arranged/designed to tighten down turnbuckle assembly 411, a shorter C channel may be employed, the support feet may be mounted to additional holes in center section 75, and the two wingers 85 may be removed.

Although the present invention has been described with reference to particular examples and exemplary embodiments, it should be understood that the foregoing description is in no manner limiting. Moreover, the features described herein may be used in any combination.

What is claimed is:

1. A truck storage system, comprising:
a deck configured to span substantially a total width of a truck bed, wherein the deck includes a center section and side sections, wherein the side sections are disposed on opposed sides of the center section and directly adjoining the center section;
four support feet, each support foot of the four support feet situated at a respective corner of the center section;
a drawer assembly comprising a single drawer situated below the center section and spanning substantially a total width of the center section, wherein the single drawer is configured to be slidable in a longitudinal direction of the truck bed; and
at least one storage compartment situated between the drawer assembly and a side of the truck bed, wherein the at least one storage compartment is structurally separate from the support feet.

2. The system of claim 1, further comprising:
at least one storage compartment lid, wherein the at least one storage compartment lid is detachably mountable along a surface of the side sections to the at least one storage compartment, wherein the at least one storage compartment lid is configured to restrict access to contents within the at least one storage compartment.

3. The system of claim 1, wherein the at least one storage compartment is at least substantially waterproof.

4. The system of claim 1, wherein the at least one storage compartment is fully removable.

5. The system of claim 1, further comprising:
a drawer tray, wherein the drawer tray is configured to support a plurality of different accessory cases disposed within the single drawer, wherein aluminum extrusions are disposed on at least one side of the drawer tray, and at least one bracket is disposed on a cab side of the drawer tray.

6. The system of claim 1, further comprising:
at least two tie down attachment members, wherein each tie down attachment member is situated between the at least one drawer assembly and the side of the truck bed.

7. The system of claim 6, further comprising:
at least two brackets, wherein each bracket connects a respective tie down attachment member to a channel extending in a longitudinal direction of the truck bed,
wherein each of the brackets is configured to support a load on the deck, anchor cargo in place, and attach the storage system to the truck bed.

8. The system of claim 7, wherein the storage system is attached to the truck bed via a turnbuckle mechanism.

9. The system of claim 6, wherein each of the at least two tie down attachment members include an attachment ring configured to fold down into a recessed cavity of the side sections and to rotate upward and swivel.

10. The system of claim 7, wherein each of the two side sections are connected to the drawer assembly via the at least two brackets, and wherein a further bracket connects the two side sections to a closeout member of the drawer assembly.

11. The system of claim 1, wherein the at least one drawer assembly has side walls that slope at an angle of at most 1 degree.

12. The system of claim 1, wherein the at least one drawer assembly is configured to extend outward of the deck by at least 75% of a length of the at least one drawer assembly.

13. The system of claim 1, wherein an upper surface of the deck has a raised pattern, wherein the raised pattern is configured to engage a relief pattern on an underside of at least one accessory case to thereby create a positive-fit connection between the deck and the at least one accessory case.

14. The system of claim 13, wherein the raised pattern covers a majority of the upper surface of the deck.

15. The system of claim 13, further comprising:
at least two tie down attachment members, each tie down attachment member situated between the at least one drawer assembly and the side of the truck bed, wherein an area between the at least two tie down attachment members does not contain the raised pattern.

16. The system of claim 1, further comprising:
lateral steel tubes spanning across the center section to the two side sections.

17. The system of claim 1, wherein the front support foot and the rear support foot are dimensionally different.

18. The system of claim 1, further comprising:
at least one closeout member which is configured to provide stability to the deck and to prevent an ingress of water into the at least one drawer assembly.

19. A truck storage system, comprising:
a deck configured to span substantially a total width of a truck bed, wherein the deck includes a center section and side sections, wherein the side sections are disposed on opposed sides of the center section and directly adjoining the center section;
four support feet, each support foot of the four support feet situated at a respective corner of the center section;
a drawer assembly comprising a single drawer situated below the center section and spanning substantially a total width of the center section, wherein the single drawer is configured to be slidable in a longitudinal direction of the truck bed;
a drawer tray, wherein the drawer tray is configured to support a plurality of different accessory cases disposed within the single drawer, wherein aluminum extrusions are disposed on at least one side of the drawer tray, and at least one bracket is disposed on a cab side of the drawer tray; and
at least one storage compartment situated between the drawer assembly and a side of the truck bed, wherein the at least one storage compartment is structurally separate from the support feet.

20. A truck storage system, comprising:
a deck configured to span substantially a total width of a truck bed, wherein the deck includes a center section and side sections, wherein the side sections are disposed on opposed sides of the center section and directly adjoining the center section;
four support feet, each support foot of the four support feet situated at a respective corner of the center section;
a drawer assembly comprising a single drawer situated below the center section and spanning substantially a total width of the center section, wherein the single drawer is configured to be slidable in a longitudinal direction of the truck bed;
at least one storage compartment situated between the drawer assembly and a side of the truck bed, wherein the at least one storage compartment is structurally separate from the support feet; and
wherein the side sections are connected to the drawer assembly via brackets, wherein the brackets are connected to the support feet and to a closeout member of the drawer assembly.
